(19) United States
(12) Patent Application Publication
(10) Pub. No.: US 2025/0116850 A1
(43) Pub. Date: Apr. 10, 2025

(54) TOUCH PAD CAPABLE OF EXHIBITING MULTIPLE MIRROR IMAGES

(71) Applicant: DARFON ELECTRONICS CORP., TAOYUAN CITY (TW)

(72) Inventor: Heng-Yi HUANG, TAOYUAN CITY (TW)

(21) Appl. No.: 18/910,442

(22) Filed: Oct. 9, 2024

Related U.S. Application Data
(60) Provisional application No. 63/543,512, filed on Oct. 10, 2023.

(30) Foreign Application Priority Data
Aug. 26, 2024 (TW) 113132048

(51) Int. Cl. G02B 17/00; F21V 8/00; G06F 3/0354

(52) U.S. Cl. CPC G02B 17/004; G02B 6/0036; G02B 6/0076; G02B 6/0088; G06F 3/03547

(57) ABSTRACT

A touch pad, capable of exhibiting multiple mirror images, includes a circuit board, a touch sensing circuit layer formed on the circuit board, a reflective layer disposed on the touch sensing circuit layer, an enclosed spacer, a light-guiding plate where a pattern region is formed, a partially reflective layer bonded on an upper surface of the light-guiding plate, at least one light-emitting device, and transparent top cover. The light-guiding plate is disposed within the enclosed spacer and is bonded on the reflective layer. The at least one light-emitting device is driven to emit a light into the light-guiding plate from a light-incident face. The incident light is repeatedly reflected between the partially reflective layer and the reflective layer, and finally exits from the partially reflective layer such that a user watches the pattern region and the multiple mirror images associated with the pattern region outside the transparent top cover.

### CROSS-REFERENCE TO RELATED APPLICATION

This utility application claims priorities to U.S. Provisional Application Ser. No. 63/543,512, filed Oct. 10, 2023, and Taiwan Application Serial Number 113132048, filed Aug. 26, 2024, the disclosures of which are incorporated herein by reference in their entireties.

### BACKGROUND OF THE INVENTION

### 1. Field of the Invention

The invention relates to a touch pad capable of exhibiting multiple mirror images.

### 2. Description of the Prior Art

Touch pads have been widely used in a variety of electronic products, such as smartphones, tablets, laptops, keyboards, and more. However, after many years of development, the appearance of touch pad remains monotonous and unchanged.

This is also known as the infinity mirror effect, which utilizes light reflecting back and forth between multiple mirrors to exhibit multiple mirror images and expand the feeling of space. The Infinity Mirror effect is utilized to enhance the aesthetics of existing objects, such as signboards and light fixtures, in order to enhance the three-dimensionality and visual layering of the objects themselves.

However, it has not yet been seen that touch pads capable of exhibiting multiple mirror images ouch panels have been developed to change the monotonous and unchanged appearance of touch pads of the prior art.

### SUMMARY OF THE INVENTION

Accordingly, one scope of the invention is to provide a touch pad capable of exhibiting multiple mirror images.

A touch pad according to a first preferred embodiment of the invention is capable of exhibiting multiple mirror images, and includes a circuit board, a touch sensing circuit layer, a reflective layer, an enclosed spacer, a light-guiding plate, a partially reflective layer, at least one light-emitting device, and a transparent top cover. The touch sensing circuit layer is formed on the circuit board. The reflective layer is disposed on the touch sensing circuit layer. The enclosed spacer is disposed on the reflective layer or the touch sensing circuit layer. The light-guiding plate has an upper surface, a lower surface and a light-incident face. The light-guiding plate includes a pattern region formed in the light-guiding plate. The light-guiding plate is placed in the enclosed spacer, and is bonded on the reflective layer via the lower surface. The partially reflective layer is bonded on the upper surface of the light-guiding plate. The at least one light-emitting device is disposed in the enclosed spacer, and is adjacent to the light-incident face of the light-guiding plate. The transparent top cover is disposed on a top of the enclosed spacer. The at least one light-emitting device is driven to emit a light into the light-guiding plate from the light-incident face. The incident light is repeatedly reflected between the partially reflective layer and the reflective layer, and finally exits from the partially reflective layer such that a user watches the pattern region and the multiple mirror images associated with the pattern region outside the transparent top cover.

In one embodiment, a gap exists between the transparent top cover and the partially reflective layer. A thickness of the gap is larger than or equal to 0 mm.

In one embodiment, the light-guiding plate is respectively bonded to the reflective layer and the partially reflective layer with an optically clear adhesive or an acrylic optically clear adhesive.

A touch pad according to a second preferred embodiment of the invention is capable of exhibiting multiple mirror images, and includes a circuit board, a touch sensing circuit layer, a reflective layer, an enclosed spacer, a first light-guiding plate, a first translucent pattern layer, a second light-guiding plate, a second translucent pattern layer, a partially reflective layer, at least one light-emitting device, and a transparent top cover. The touch sensing circuit layer is formed on the circuit board. The reflective layer is disposed on the touch sensing circuit layer. The enclosed spacer is disposed on the reflective layer or the touch sensing circuit layer. The first light-guiding plate has a first upper surface, a first lower surface and a first light-incident face. The first light-guiding plate is placed in the enclosed spacer, and is bonded on the reflective layer via the first lower surface. The first translucent pattern layer is locally formed on the first upper surface of the first light-guiding plate. The second light-guiding plate has a second upper surface, a second lower surface and a second light-incident face. The second light-guiding plate is placed in the enclosed spacer, and is placed on the first translucent pattern layer and the first light-guiding plate. The second translucent pattern layer is locally formed on the second upper surface of the second light-guiding plate. The partially reflective layer is bonded on the second translucent pattern layer and the second upper surface of the second light-guiding plate. The at least one light-emitting device is disposed in the enclosed spacer, and is adjacent to the first light-incident face of the first light-guiding plate and the second light-incident face of the second light-guiding plate. The transparent top cover is disposed on a top of the enclosed spacer. The at least one light-emitting device is driven to emit a light into the first light-guiding plate and the second light-guiding plate from the first light-incident face and the second light-incident face. The incident light is repeatedly reflected between the partially reflective layer and the reflective layer, and finally exits from the partially reflective layer such that a user watches the first translucent pattern layer, the second translucent pattern layer and the multiple mirror images associated with the first translucent pattern layer and the second translucent pattern layer outside the transparent top cover.

A touch pad according to a third preferred embodiment of the invention is capable of exhibiting multiple mirror images, and includes a circuit board, a touch sensing circuit layer, an enclosed spacer, a circular light-guiding plate, a reflective layer, a partially reflective layer, at least one light-emitting device, and a transparent top cover. The touch sensing circuit layer is formed on the circuit board. The enclosed spacer is disposed on the touch sensing circuit layer. The circular light-guiding plate has an upper surface, a lower surface and a light-incident face. The circular light-guiding plate includes a pattern region formed in the circular light-guiding plate. The circular light-guiding plate matches the enclosed spacer, and is disposed to surround the enclosed spacer. The reflective layer is bonded on the lower surface of the circular light-guiding plate. The partially reflective layer is bonded on the upper surface of the circular light-guiding plate. The at least one light-emitting device is disposed adjacent to the light-incident face of the circular light-guiding plate. The transparent top cover is disposed on a top of the enclosed spacer. The transparent top cover also covers above the partially reflective layer. The at least one light-emitting device is driven to emit a light into the circular light-guiding plate from the light-incident face. The incident light is repeatedly reflected between the partially reflective layer and the reflective layer, and finally exits from the partially reflective layer such that a user watches the pattern region and the multiple mirror images associated with the pattern region outside the transparent top cover.

A touch pad according to a fourth preferred embodiment of the invention is capable of exhibiting multiple mirror images, and includes a circuit board, a touch sensing circuit layer, an enclosed spacer, a first circular light-guiding plate, a reflective layer, a first translucent pattern layer, a second circular light-guiding plate, a second translucent pattern layer, a partially reflective layer, at least one light-emitting device, and a transparent top cover. The touch sensing circuit layer is formed on the circuit board. The enclosed spacer is disposed on the touch sensing circuit layer. The first circular light-guiding plate has a first upper surface, a first lower surface and a first light-incident face. The first circular light-guiding plate matches the enclosed spacer, and is disposed to surround the enclosed spacer. The reflective layer is bonded on of the first lower surface of the first circular light-guiding plate. The first translucent pattern layer is locally formed on the first upper surface of the first circular light-guiding plate. The second circular light-guiding plate has a second upper surface, a second lower surface and a second light-incident face. The second circular light-guiding plate matches the enclosed spacer, is placed on the first translucent pattern layer and the first circular light-guiding plate, and surrounds the enclosed spacer. The second translucent pattern layer is locally formed on the second upper surface of the second circular light-guiding plate. The partially reflective layer is bonded on the second translucent pattern layer and the second upper surface of the second circular light-guiding plate. The at least one light-emitting device is disposed adjacent to the first light-incident face of the first circular light-guiding plate and the second light-incident face of the second circular light-guiding plate. The transparent top cover is disposed on a top of the enclosed spacer. The transparent top cover also covers above the partially reflective layer. The at least one light-emitting device is driven to emit a light into the first circular light-guiding plate and the second circular light-guiding plate from the first light-incident face and the second light-incident face. The incident light is repeatedly reflected between the partially reflective layer and the reflective layer, and finally exits from the partially reflective layer such that a user watches the first translucent pattern layer, the second translucent pattern layer and the multiple mirror images associated with the first translucent pattern layer and the second translucent pattern layer outside the transparent top cover.

Different from the touch pad of the prior art with monotonous and unchanged appearance, the touch pad according to the invention is capable of exhibiting multiple mirror images and expanding the feeling of space.

The advantage and spirit of the invention may be understood by the following recitations together with the appended drawings.

### BRIEF DESCRIPTION OF THE APPENDED DRAWINGS

FIG. 1 is a top view of the touch pad capable of exhibiting multiple mirror images according to the first preferred embodiment of the invention.

FIG. 2 is a cross-sectional view of the touch pad capable of exhibiting multiple mirror images in FIG. 1 along the line A-A.

FIG. 3 is a top view of the touch pad capable of exhibiting multiple mirror images according to the second preferred embodiment of the invention.

FIG. 4 is a cross-sectional view of the touch pad capable of exhibiting multiple mirror images in FIG. 3 along the line B-B.

FIG. 5 is a top view of the touch pad capable of exhibiting multiple mirror images according to the third preferred embodiment of the invention.

FIG. 6 is a cross-sectional view of the touch pad capable of exhibiting multiple mirror images in FIG. 5 along the line C-C.

FIG. 7 is a top view of the touch pad capable of exhibiting multiple mirror images according to the fourth preferred embodiment of the invention.

FIG. 8 is a cross-sectional view of the touch pad capable of exhibiting multiple mirror images in FIG. 7 along the line D-D.

### DETAILED DESCRIPTION OF THE INVENTION

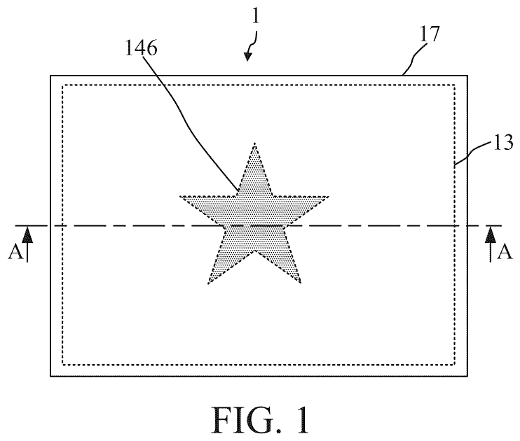

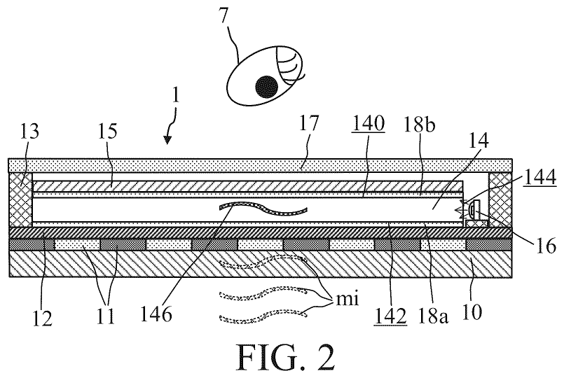

Referring to FIG. 1 and FIG. 2, those drawings schematically illustrate the touch pad 1 capable of exhibiting multiple mirror images according to the first preferred embodiment of the invention. FIG. 1 schematically illustrates with a top view the touch pad 1 capable of exhibiting multiple mirror images according to the first preferred embodiment of the invention. FIG. 2 is a cross-sectional view of the touch pad 1 capable of exhibiting multiple mirror images in FIG. 1 along the line A-A.

As shown in FIG. 1 and FIG. 2, the touch pad 1 capable of exhibiting multiple mirror images, according to the first preferred embodiment of the invention, includes a circuit board 10, a touch sensing circuit layer 11, a reflective layer 12, an enclosed spacer 13, a light-guiding plate 14, a partially reflective layer 15, at least one light-emitting device 16, and a transparent top cover 17.

The touch sensing circuit layer 11 is formed on the circuit board 10. The reflective layer 12 is disposed on the touch sensing circuit layer 11. The enclosed spacer 13 is disposed on the reflective layer 12 or the touch sensing circuit layer 11. In the example shown in FIG. 2, the enclosed spacer 13 is disposed on the reflective layer 12.

The light-guiding plate 14 has an upper surface 140, a lower surface 142 and a light-incident face 144. The light-guiding plate 14 includes a pattern region 146. The pattern region 146 is formed in the light-guiding plate 14. The light-guiding plate 14 is placed in the enclosed spacer 13, and is bonded on the reflective layer 12 via the lower surface 142. The partially reflective layer 15 is bonded on the upper surface 140 of the light-guiding plate 14. It should be emphasized that the reflectivity of the reflective layer 12 is greater than the reflectivity of the partially reflective layer 15.

In one embodiment, the light-guiding plate 14 can be made of polyethylene terephthalate (PET), poly (methyl methacrylate) (PMMA), glass, acrylic, silicone, thermoplastic polyurethane (TPU), or other commercially available light-guiding polymer materials. The thickness of the light-guiding plate 14 can be determined according to the need without any special limitation.

In one embodiment, the light-guiding plate 14 can be respectively bonded to the reflective layer 12 and the partially reflective layer 15 with an optically clear adhesive or an acrylic optically clear adhesive to form the adhesion layer 18a and the adhesion layer 18b as shown in FIG. 2. Thereby, the optically clear adhesive or optically clear acrylic adhesive prevent bubbling or multiple reflections from occurring in the adhesion layer 18a between the light-guiding plate 14 and the reflective layer 12 and the adhesion layer 18b between the light-guiding plate 14 and the partially reflective layer 15, respectively.

In one embodiment, the reflective layer 12 and the partially reflective layer 15 can be mylars, or PET polyester films, respectively. The reflective layer 12 and the partially reflective layer 15 can also be films coated on the lower surface 142 and the upper surface 140 of the light guide plate 14, respectively.

In one embodiment, the pattern region 146 can be formed in the light-guiding plate 14 by a printing process or a laser engraving process. Alternatively, the light-guide plate 14 is formed by combining multiple layers of structures, and the pattern region 146 can be formed by forming mesh dots or inlaying objects such as fluorescents within the multiple layers of structures, but the invention is not limited thereto.

The at least one light-emitting device 16 is disposed in the enclosed spacer 13, and is adjacent to the light-incident face 144 of the light-guiding plate 14. In the example shown in FIG. 2, the light-incident face 144 is provided by sides immediately adjacent the upper surface 140 and the lower surface 142. The light-incident face 144 can also be provided by an inner wall of a depression (not shown in the figures) formed on the lower surface 142 of the light-guiding plate 14.

The transparent top cover 17 is disposed on a top 130 of the enclosed spacer 13. The at least one light-emitting device 16 is driven to emit a light into the light-guiding plate 14 from the light-incident face 144. The incident light is repeatedly reflected between the partially reflective layer 15 and the reflective layer 12, and finally exits from the partially reflective layer 15 such that a user 7 watches the pattern region 146 and the multiple mirror images mi associated with the pattern region 146 outside the transparent top cover 17. It should be noted that in FIG. 2, the multiple mirror images mi are drawn outside of the reflective layer 12 to indicate that the multiple mirror images mi are mirrored images rather than solid structures.

In one embodiment, each light-emitting device 16 can be a light-emitting diode or an organic light-emitting diode, but the invention is not limited thereto.

In one embodiment, a gap exists between the transparent top cover 17 and the partially reflective layer 15. A thickness of the gap is larger than or equal to 0 mm. If the thickness of the gap is greater than 0 mm, i.e., there is an air layer between the transparent top cover 17 and the partially reflective layer 15. This air layer can enhance the effect of multiple mirroring of the touch pad 1 capable of exhibiting multiple mirror images according to the first preferred embodiment of the invention.

In one embodiment, the transparent top cover 17 can be formed of a dielectric material. The dielectric material can be glass, acrylic, ceramic, and the like.

In one embodiment, the structure of the touch sensing circuit layer 11 can be used to perform a projected capacitive touch pad function or an ultrasonic touch pad function, but the invention is not limited thereto. When the touch sensing circuit layer 11 is structured to perform a projected capacitive touch pad function, the reflective layer 12 shall be insulated.

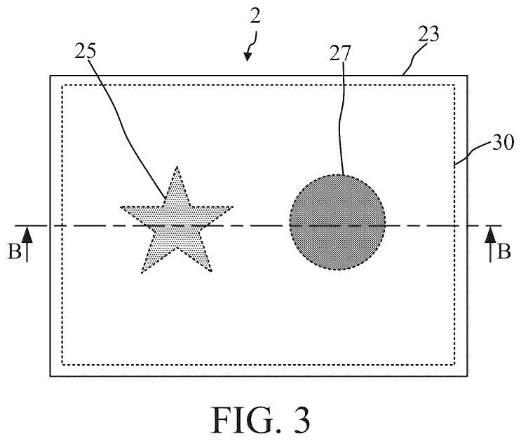

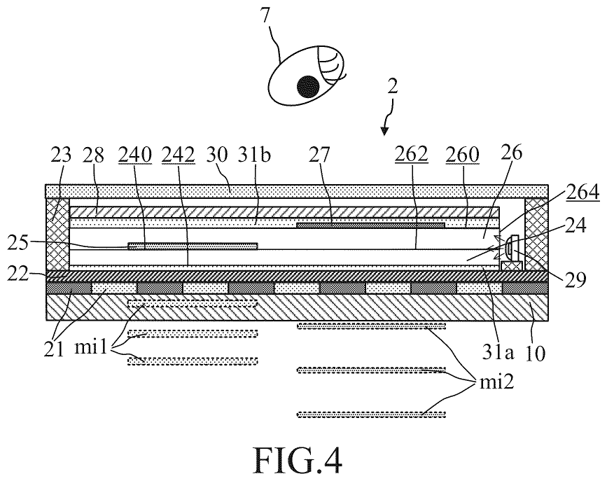

Referring to FIG. 3 and FIG. 4, those drawings schematically illustrate the touch pad 2 capable of exhibiting multiple mirror images according to the second preferred embodiment of the invention. FIG. 3 schematically illustrates with a top view the touch pad 2 capable of exhibiting multiple mirror images according to the second preferred embodiment of the invention. FIG. 4 is a cross-sectional view of the touch pad 2 capable of exhibiting multiple mirror images in FIG. 3 along the line B-B.

As shown in FIG. 3 and FIG. 4, the touch pad 2 capable of exhibiting multiple mirror images, according to the second preferred embodiment of the invention, includes a circuit board 20, a touch sensing circuit layer 21, a reflective layer 22, an enclosed spacer 23, a first light-guiding plate 24, a first translucent pattern layer 25, a second light-guiding plate 26, a second translucent pattern layer 27, a partially reflective layer 28, at least one light-emitting device 29, and a transparent top cover 30.

The touch sensing circuit layer 21 is formed on the circuit board 20. The reflective layer 22 is disposed on the touch sensing circuit layer 21. The enclosed spacer 23 is disposed on the reflective layer 22 or the touch sensing circuit layer 21. In the example shown in FIG. 4, the enclosed spacer 23 is disposed on the reflective layer 22.

The first light-guiding plate 24 has a first upper surface 240, a first lower surface 242 and a first light-incident face 244. The first light-guiding plate 24 is placed in the enclosed spacer 23, and is bonded on the reflective layer 22 via the first lower surface 242. The first translucent pattern layer 25 is locally formed on the first upper surface 240 of the first light- guiding plate 24. The second light-guiding plate 26 has a second upper surface 260, a second lower surface 262 and a second light-incident face 264. The second light-guiding plate 26 is placed in the enclosed spacer 23, and is placed on the first translucent pattern layer 25 and the first light-guiding plate 24. The second translucent pattern layer 27 is locally formed on the second upper surface 260 of the second light-guiding plate 26. The partially reflective layer 28 is bonded on the second translucent pattern layer 27 and the second upper surface 260 of the second light-guiding plate 26. It should be emphasized that the reflectivity of the reflective layer 22 is greater than the reflectivity of the partially reflective layer 28.

In one embodiment, the first light-guiding plate 24 and the second light-guiding plate 26 can be made of polyethylene terephthalate (PET), poly (methyl methacrylate) (PMMA), glass, acrylic, silicone, thermoplastic polyurethane (TPU), or other commercially available light-guiding polymer materials. The thicknesses of the first light-guiding plate 24 and the second light-guiding plate 26 can be determined according to the need without any special limitation.

In one embodiment, the first light-guiding plate 24 and the second light-guiding plate 26 can be respectively bonded to the reflective layer 22 and the partially reflective layer 28 with an optically clear adhesive or an acrylic optically clear adhesive to form the adhesion layer 31a and the adhesion layer 31b as shown in FIG. 4. Thereby, the optically clear adhesive or optically clear acrylic adhesive prevent bubbling or multiple reflections from occurring in the adhesion layer 31a between the first light-guiding plate 24 and the reflective layer 22 and the adhesion layer 31b between the second light-guiding plate 26 and the partially reflective layer 28, respectively.

In one embodiment, the reflective layer 22 and the partially reflective layer 28 can be mylars, or PET polyester films, respectively. The reflective layer 22 and the partially reflective layer 28 can also be films coated on the first lower surface 242 of the first light-guiding plate 24 and the second upper surface 260 of the second light guide plate 26, respectively.

In one embodiment, the first pattern region 25 and the second pattern region 27 can be respectively formed on the first upper surface 240 of the first light-guiding plate 24 and the second upper surface 260 of the second light-guiding plate 26 by a printing process or a laser engraving process, but the invention is not limited thereto.

The at least one light-emitting device 29 is disposed in the enclosed spacer 23, and is adjacent to the first light-incident face 244 of the first light-guiding plate 24 and the second light-incident face 264 of the second light-guiding plate 26. In the example shown in FIG. 4, the first light-incident face 244 is provided by sides immediately adjacent the first upper surface 240 and the first lower surface 242, and the second light-incident face 264 is provided by sides immediately adjacent the second upper surface 260 and the second lower surface 262. The first light-incident face 244 can also be provided by an inner wall of a depression (not shown in the figures) formed on the first lower surface 242 of the first light-guiding plate 24, the second light-incident face 264 can also be provided by an inner wall of a depression (not shown in the figures) formed on the second lower surface 262 of the second light-guiding plate 26.

The transparent top cover 30 is disposed on a top 300 of the enclosed spacer 23. The at least one light-emitting device 29 is driven to emit a light into the first light-guiding plate 24 and the second light-guiding plate 26 from the first light-incident face 244 and the second light-incident face 264. The incident light is repeatedly reflected between the partially reflective layer 28 and the reflective layer 22, and finally exits from the partially reflective layer 28 such that a user 7 watches the first translucent pattern layer 25, the second translucent pattern layer 27, multiple first mirror images mil associated with the first translucent pattern layer 25 and multiple second mirror images mi2 associated with the second translucent pattern layer 27 outside the transparent top cover 30. It should be noted that in FIG. 4, the multiple first mirror images mi1 and the multiple second mirror images mi2 are drawn outside of the reflective layer 22 to indicate that the multiple first mirror images mi1 and the multiple second mirror images mi2 are mirrored images rather than solid structures.

In one embodiment, each light-emitting device 29 can be a light-emitting diode or an organic light-emitting diode, but the invention is not limited thereto.

In one embodiment, a gap exists between the transparent top cover 30 and the partially reflective layer 28. A thickness of the gap is larger than or equal to 0 mm. If the thickness of the gap is greater than 0 mm, i.e., there is an air layer between the transparent top cover 30 and the partially reflective layer 28. This air layer can enhance the effect of multiple mirroring of the touch pad 2 capable of exhibiting multiple mirror images according to the second preferred embodiment of the invention.

In one embodiment, the transparent top cover 30 can be formed of a dielectric material. The dielectric material can be glass, acrylic, ceramic, and the like.

In one embodiment, the structure of the touch sensing circuit layer 21 can be used to perform a projected capacitive touch pad function or an ultrasonic touch pad function, but the invention is not limited thereto. When the touch sensing circuit layer 21 is structured to perform a projected capacitive touch pad function, the reflective layer 22 shall be insulated.

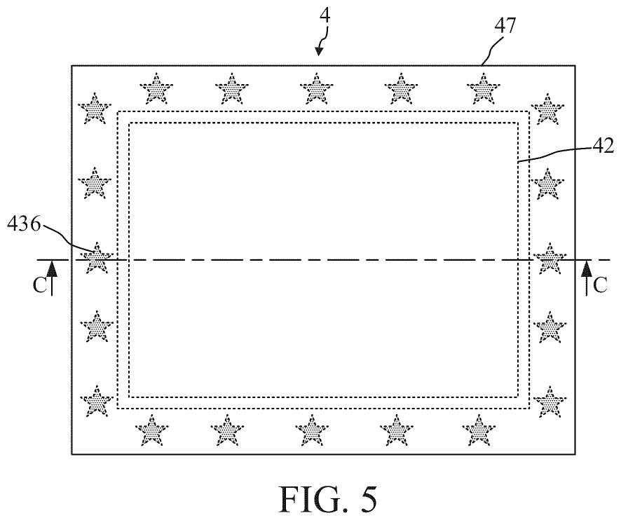

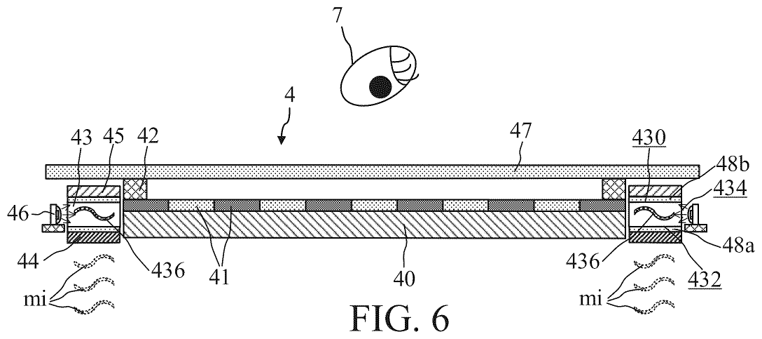

Referring to FIG. 5 and FIG. 6, those drawings schematically illustrate the touch pad 4 capable of exhibiting multiple mirror images according to the third preferred embodiment of the invention. FIG. 5 schematically illustrates with a top view the touch pad 4 capable of exhibiting multiple mirror images according to the third preferred embodiment of the invention. FIG. 6 is a cross-sectional view of the touch pad 4 capable of exhibiting multiple mirror images in FIG. 5 along the line C-C.

As shown in FIG. 5 and FIG. 6, the touch pad 4 capable of exhibiting multiple mirror images, according to the third preferred embodiment of the invention, includes a circuit board 40, a touch sensing circuit layer 41, an enclosed spacer 42, a circular light-guiding plate 43, a reflective layer 44, a partially reflective layer 45, at least one light-emitting device 46, and a transparent top cover 47.

The touch sensing circuit layer 41 is formed on the circuit board 40. The enclosed spacer 42 is disposed on the touch sensing circuit layer 41. The circular light-guiding plate 43 has an upper surface 430, a lower surface 432 and a light-incident face 434. The circular light-guiding plate 43 includes a pattern region 436. The pattern region 436 is formed in the circular light-guiding plate 43. The circular light-guiding plate 43 matches the enclosed spacer 42, and is disposed to surround the enclosed spacer 42. The reflective layer 44 is bonded on the lower surface 432 of the circular light-guiding plate 43. The partially reflective layer 45 is bonded on the upper surface 430 of the circular light-guiding plate 43. It should be emphasized that the reflectivity of the reflective layer 44 is greater than the reflectivity of the partially reflective layer 45.

In one embodiment, the circular light-guiding plate 43 can be made of polyethylene terephthalate (PET), poly (methyl methacrylate) (PMMA), glass, acrylic, silicone, thermoplastic polyurethane (TPU), or other commercially available light-guiding polymer materials. The thickness of the circular light-guiding plate 43 can be determined according to the need without any special limitation.

In one embodiment, the circular light-guiding plate 43 can be respectively bonded to the reflective layer 44 and the partially reflective layer 45 with an optically clear adhesive or an acrylic optically clear adhesive to form the adhesion layer 48a and the adhesion layer 48b as shown in FIG. 6. Thereby, the optically clear adhesive or optically clear acrylic adhesive prevent bubbling or multiple reflections from occurring in the adhesion layer 48a between the circular light-guiding plate 43 and the reflective layer 44 and the adhesion layer 48b between the circular light-guiding plate 43 and the partially reflective layer 45, respectively.

In one embodiment, the reflective layer 44 and the partially reflective layer 45 can be mylars, or PET polyester films, respectively. The reflective layer 44 and the partially reflective layer 45 can also be films coated on the lower surface 432 and the upper surface 430 of the circular light guide plate 43, respectively.

In one embodiment, the pattern region 436 can be formed in the circular light-guiding plate 43 by a printing process or a laser engraving process. Alternatively, the circular light-guide plate 43 is formed by combining multiple layers of structures, and the pattern region 436 can be formed by forming mesh dots or inlaying objects such as fluorescents within the multiple layers of structures, but the invention is not limited thereto.

The at least one light-emitting device 46 is disposed adjacent to the light-incident face 434 of the circular light-guiding plate 43. In the example shown in FIG. 6, the light-incident face 434 is provided by sides immediately adjacent the upper surface 430 and the lower surface 432. The light-incident face 434 can also be provided by an inner wall of a depression (not shown in the figures) formed on the lower surface 432 of the circular light-guiding plate 43.

The transparent top cover 47 is disposed on a top 420 of the enclosed spacer 42. In particular, the transparent top cover 47 also covers above the partially reflective layer 45. The at least one light-emitting device 46 is driven to emit a light into the circular light-guiding plate 43 from the light-incident face 434. The incident light is repeatedly reflected between the partially reflective layer 45 and the reflective layer 44, and finally exits from the partially reflective layer 45 such that a user 7 watches the pattern region 436 and the multiple mirror images mi associated with the pattern region 436 outside the transparent top cover 47. It should be noted that in FIG. 6, the multiple mirror images mi are drawn outside of the reflective layer 44 to indicate that the multiple mirror images mi are mirrored images rather than solid structures.

In one embodiment, each light-emitting device 46 can be a light-emitting diode or an organic light-emitting diode, but the invention is not limited thereto.

In one embodiment, a gap exists between the transparent top cover 47 and the partially reflective layer 45. A thickness of the gap is larger than or equal to 0 mm. If the thickness of the gap is greater than 0 mm, i.e., there is an air layer between the transparent top cover 47 and the partially reflective layer 45. This air layer can enhance the effect of multiple mirroring of the touch pad 4 capable of exhibiting multiple mirror images according to the third preferred embodiment of the invention.

In one embodiment, the transparent top cover 47 can be formed of a dielectric material. The dielectric material can be glass, acrylic, ceramic, and the like.

In one embodiment, the structure of the touch sensing circuit layer 41 can be used to perform a projected capacitive touch pad function or an ultrasonic touch pad function, but the invention is not limited thereto.

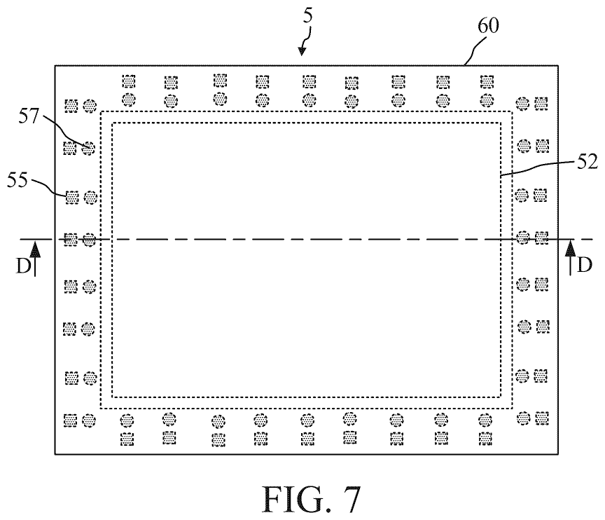

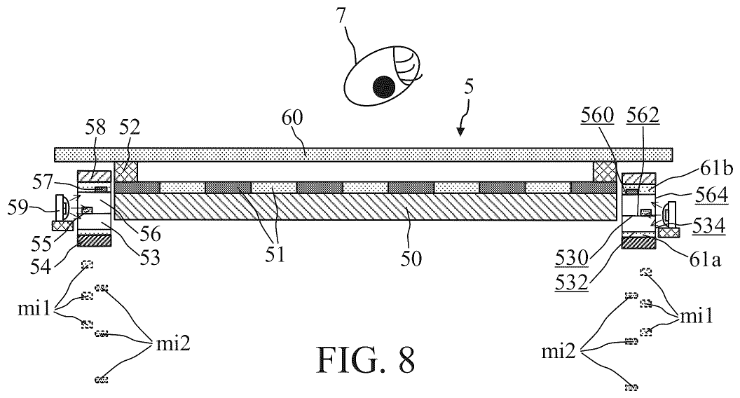

Referring to FIG. 7 and FIG. 8, those drawings schematically illustrate the touch pad 5 capable of exhibiting multiple mirror images according to the fourth preferred embodiment of the invention. FIG. 7 schematically illustrates with a top view the touch pad 5 capable of exhibiting multiple mirror images according to the fourth preferred embodiment of the invention. FIG. 8 is a cross-sectional view of the touch pad 5 capable of exhibiting multiple mirror images in FIG. 7 along the line D-D.

As shown in FIG. 7 and FIG. 8, the touch pad 5 capable of exhibiting multiple mirror images, according to the fourth preferred embodiment of the invention, includes a circuit board 50, a touch sensing circuit layer 51, an enclosed spacer 52, a first circular light-guiding plate 53, a reflective layer 54, a first translucent pattern layer 55, a second circular light-guiding plate 56, a second translucent pattern layer 57, a partially reflective layer 58, at least one light-emitting device 59, and a transparent top cover 60.

The touch sensing circuit layer 51 is formed on the circuit board 50. The enclosed spacer 52 is disposed on the touch sensing circuit layer 51. The first circular light-guiding plate 53 has a first upper surface 530, a first lower surface 532 and a first light-incident face 534. The first circular light-guiding plate 53 matches the enclosed spacer 52, and is disposed to surround the enclosed spacer 52. The reflective layer 54 is bonded on of the first lower surface 532 of the first circular light-guiding plate 53. The first translucent pattern layer 55 is locally formed on the first upper surface 530 of the first circular light-guiding plate 53. The second circular light-guiding plate 56 has a second upper surface 560, a second lower surface 562 and a second light-incident face 564. The second circular light-guiding plate 56 matches the enclosed spacer 52, is placed on the first translucent pattern layer 55 and the first circular light-guiding plate 53, and surrounds the enclosed spacer 52. The second translucent pattern layer 57 is locally formed on the second upper surface 560 of the second circular light-guiding plate 56. The partially reflective layer 58 is bonded on the second translucent pattern layer 57 and the second upper surface 560 of the second circular light-guiding plate 56. It should be emphasized that the reflectivity of the reflective layer 54 is greater than the reflectivity of the partially reflective layer 58.

In one embodiment, the first circular light-guiding plate 53 and the second circular light-guiding plate 56 can be made of polyethylene terephthalate (PET), poly (methyl methacrylate) (PMMA), glass, acrylic, silicone, thermoplastic polyurethane (TPU), or other commercially available light-guiding polymer materials. The thicknesses of the first circular light-guiding plate 53 and the second circular light-guiding plate 56 can be determined according to the need without any special limitation.

In one embodiment, the first circular light-guiding plate 53 and the second circular light-guiding plate 56 can be respectively bonded to the reflective layer 54 and the partially reflective layer 58 with an optically clear adhesive or an acrylic optically clear adhesive to form the adhesion layer 61a and the adhesion layer 61b as shown in FIG. 8. Thereby, the optically clear adhesive or optically clear acrylic adhesive prevent bubbling or multiple reflections from occurring in the adhesion layer 61a between the first circular light-guiding plate 53 and the reflective layer 54 and the adhesion layer 61b between the second circular light-guiding plate 56 and the partially reflective layer 58, respectively.

In one embodiment, the reflective layer 54 and the partially reflective layer 58 can be mylars, or PET polyester films, respectively. The reflective layer 54 and the partially reflective layer 58 can also be films coated on the first lower surface 532 of the first circular light-guiding plate 53 and the second upper surface 560 of the second circular light guide plate 56, respectively.

In one embodiment, the first pattern region 55 and the second pattern region 57 can be respectively formed on the first upper surface 530 of the first circular light-guiding plate 53 and the second upper surface 560 of the second circular light-guiding plate 56 by a printing process or a laser engraving process, but the invention is not limited thereto.

The at least one light-emitting device 59 is disposed adjacent to the first light-incident face 534 of the first circular light-guiding plate 53 and the second light-incident face 564 of the second circular light-guiding plate 56. In the example shown in FIG. 8, the first light-incident face 534 is provided by sides immediately adjacent the first upper surface 530 and the first lower surface 532, and the second light-incident face 564 is provided by sides immediately adjacent the second upper surface 560 and the second lower surface 562. The first light-incident face 534 can also be provided by an inner wall of a depression (not shown in the figures) formed on the first lower surface 532 of the first circular light-guiding plate 53, the second light-incident face 564 can also be provided by an inner wall of a depression (not shown in the figures) formed on the second lower surface 562 of the second circular light-guiding plate 56.

The transparent top cover 60 is disposed on a top 520 of the enclosed spacer 52. The transparent top cover 60 also covers above the partially reflective layer 58. The at least one light-emitting device 59 is driven to emit a light into the first circular light-guiding plate 53 and the second circular light-guiding plate 56 from the first light-incident face 534 and the second light-incident face 564. The incident light is repeatedly reflected between the partially reflective layer 58 and the reflective layer 54, and finally exits from the partially reflective layer 58 such that a user 7 watches the first translucent pattern layer 55, the second translucent pattern layer 57, multiple first mirror images mi1 associated with the first translucent pattern layer 55 and multiple second mirror images mi2 associated with the second translucent pattern layer 57 outside the transparent top cover 60. It should be noted that in FIG. 8, the multiple first mirror images mi1 and the multiple second mirror images mi2 are drawn outside of the reflective layer 54 to indicate that the multiple first mirror images mi1 and the multiple second mirror images mi2 are mirrored images rather than solid structures.

In one embodiment, each light-emitting device 59 can be a light-emitting diode or an organic light-emitting diode, but the invention is not limited thereto.

In one embodiment, a gap exists between the transparent top cover 60 and the partially reflective layer 58. A thickness of the gap is larger than or equal to 0 mm. If the thickness of the gap is greater than 0 mm, i.e., there is an air layer between the transparent top cover 60 and the partially reflective layer 58. This air layer can enhance the effect of multiple mirroring of the touch pad 5 capable of exhibiting multiple mirror images according to the fourth preferred embodiment of the invention.

In one embodiment, the transparent top cover 60 can be formed of a dielectric material. The dielectric material can be glass, acrylic, ceramic, and the like.

In one embodiment, the structure of the touch sensing circuit layer 51 can be used to perform a projected capacitive touch pad function or an ultrasonic touch pad function, but the invention is not limited thereto.

With the detailed description of the above preferred embodiments of the invention, it is clear to understand that different from the touch pad of the prior art with monotonous and unchanged appearance, the touch pad according to the invention is capable of exhibiting multiple mirror images and expanding the feeling of space.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A touch pad, capable of exhibiting multiple mirror images, comprising:
a circuit board;
a touch sensing circuit layer, formed on the circuit board;
a reflective layer, disposed on the touch sensing circuit layer;
an enclosed spacer, disposed on the reflective layer or the touch sensing circuit layer;
a light-guiding plate, having an upper surface, a lower surface and a light-incident face, the light-guiding plate comprising a pattern region formed in the light-guiding plate, the light-guiding plate being placed in the enclosed spacer and being bonded on the reflective layer via the lower surface;
a partially reflective layer, bonded on the upper surface of the light-guiding plate;
at least one light-emitting device, disposed in the enclosed spacer and being adjacent to the light-incident face; and
a transparent top cover, disposed on a top of the enclosed spacer;
wherein the at least one light-emitting device is driven to emit a light into the light-guiding plate from the light-incident face, the incident light is repeatedly reflected between the partially reflective layer and the reflective layer, and finally exits from the partially reflective layer such that a user watches the pattern region and the multiple mirror images associated with the pattern region outside the transparent top cover.

2. The touch pad of claim 1, wherein a gap exists between the transparent top cover and the partially reflective layer, a thickness of the gap is larger than or equal to 0 mm.

3. The touch pad of claim 2, wherein the light-guiding plate is respectively bonded to the reflective layer and the partially reflective layer with an optically clear adhesive or an acrylic optically clear adhesive.

4. A touch pad, capable of exhibiting multiple mirror images, comprising:
a circuit board;
a touch sensing circuit layer, formed on the circuit board;
a reflective layer, disposed on the touch sensing circuit layer;
an enclosed spacer, disposed on the reflective layer or the touch sensing circuit layer;
a first light-guiding plate, having a first upper surface, a first lower surface and a first light-incident face, the first light-guiding plate being placed in the enclosed spacer and being bonded on the reflective layer via the first lower surface;
a first translucent pattern layer, locally formed on the first upper surface of the first light-guiding plate;
a second light-guiding plate, having a second upper surface, a second lower surface and a second light-incident face, the second light-guiding plate being placed in the enclosed spacer and being placed on the first translucent pattern layer and the first light-guiding plate;
a second translucent pattern layer, locally formed on the second upper surface of the second light-guiding plate;
a partially reflective layer, bonded on the second translucent pattern layer and the second upper surface of the second light-guiding plate;
at least one light-emitting device, disposed in the enclosed spacer and being adjacent to the first light-incident face of the first light-guiding plate and the second light-incident face of the second light-guiding plate; and
a transparent top cover, disposed on a top of the enclosed spacer;
wherein the at least one light-emitting device is driven to emit a light into the first light-guiding plate and the second light-guiding plate from the first light-incident face and the second light-incident face, the incident light is repeatedly reflected between the partially reflective layer and the reflective layer, and finally exits from the partially reflective layer such that a user watches the first translucent pattern layer, the second translucent pattern layer and the multiple mirror images associated with the first translucent pattern layer and the second translucent pattern layer outside the transparent top cover.

5. The touch pad of claim 4, wherein a gap exists between the transparent top cover and the partially reflective layer, a thickness of the gap is larger than or equal to 0 mm.

6. The touch pad of claim 5, wherein the first light-guiding plate and the second light-guiding plate are respectively bonded to the reflective layer and the partially reflective layer with an optically clear adhesive or an acrylic optically clear adhesive.

7. A touch pad, capable of exhibiting multiple mirror images, comprising:
a circuit board;
a touch sensing circuit layer, formed on the circuit board;
an enclosed spacer, disposed on the touch sensing circuit layer;
a circular light-guiding plate, having an upper surface, a lower surface and a light-incident face, the circular light-guiding plate comprising a pattern region formed in the circular light-guiding plate, the circular light-guiding plate matching the enclosed spacer and being disposed to surround the enclosed spacer;
a reflective layer, bonded on the lower surface of the circular light-guiding plate;
a partially reflective layer, bonded on the upper surface of the circular light-guiding plate;
at least one light-emitting device, disposed adjacent to the light-incident face of the circular light-guiding plate; and
a transparent top cover, disposed on a top of the enclosed spacer, the transparent top cover also covering above the partially reflective layer;
wherein the at least one light-emitting device is driven to emit a light into the circular light-guiding plate from the light-incident face, the incident light is repeatedly reflected between the partially reflective layer and the reflective layer, and finally exits from the partially reflective layer such that a user watches the pattern region and the multiple mirror images associated with the pattern region outside the transparent top cover.

8. The touch pad of claim 7, wherein a gap exists between the transparent top cover and the partially reflective layer, a thickness of the gap is larger than or equal to 0 mm, the circular light-guiding plate is respectively bonded to the reflective layer and the partially reflective layer with an optically clear adhesive or an acrylic optically clear adhesive.

9. A touch pad, capable of exhibiting multiple mirror images, comprising:
a circuit board;
a touch sensing circuit layer, formed on the circuit board;
an enclosed spacer, disposed on the touch sensing circuit layer;
a first circular light-guiding plate, having a first upper surface, a first lower surface and a first light-incident face, the first circular light-guiding plate matching the enclosed spacer and being disposed to surround the enclosed spacer;
a reflective layer, bonded on of the first lower surface of the first circular light-guiding plate;
a first translucent pattern layer, locally formed on the first upper surface of the first circular light-guiding plate;
a second circular light-guiding plate, having a second upper surface, a second lower surface and a second light-incident face, the second circular light-guiding plate matching the enclosed spacer, being placed on the first translucent pattern layer and the first circular light-guiding plate and surrounding the enclosed spacer;
a second translucent pattern layer, locally formed on the second upper surface of the second circular light-guiding plate;
a partially reflective layer, bonded on the second translucent pattern layer and the second upper surface of the second circular light-guiding plate;
at least one light-emitting device, disposed adjacent to the first light-incident face of the first circular light-guiding plate and the second light-incident face of the second circular light-guiding plate; and
a transparent top cover, disposed on a top of the enclosed spacer, the transparent top cover also covering above the partially reflective layer;
wherein the at least one light-emitting device is driven to emit a light into the first circular light-guiding plate and the second circular light-guiding plate from the first light-incident face and the second light-incident face, the incident light is repeatedly reflected between the partially reflective layer and the reflective layer, and finally exits from the partially reflective layer such that a user watches the first translucent pattern layer, the second translucent pattern layer and the multiple mirror images associated with the first translucent pattern layer and the second translucent pattern layer outside the transparent top cover.

10. The touch pad of claim 9, wherein a gap exists between the transparent top cover and the partially reflective layer, a thickness of the gap is larger than or equal to 0 mm, the first circular light-guiding plate and the second circular light-guiding plate are respectively bonded to the reflective layer and the partially reflective layer with an optically clear adhesive or an acrylic optically clear adhesive.
